(19) United States
(12) Patent Application Publication
(10) Pub. No.: US 2015/0161666 A1
(43) Pub. Date: Jun. 11, 2015

(54) OPERATION METHOD OF PORTABLE ELECTRONIC APPARATUS

(71) Applicant: Cho-Yi Lin, New Taipei City (TW)

(72) Inventors: Hong Fan Wei, Taipei City (TW); Cho-Yi Lin, Taipei City (TW)

(21) Appl. No.: 14/529,355

(22) Filed: Oct. 31, 2014

Related U.S. Application Data
(60) Provisional application No. 61/914,041, filed on Dec. 10, 2013.

(51) Int. Cl. G06Q 30/02

(52) U.S. Cl. CPC G06Q 30/0262; G06Q 30/0267

(57) ABSTRACT

An operation method of a portable electronic apparatus includes the following steps. At least one advertisement data is downloaded into a memory of the portable electronic apparatus according to a predetermined rule. An input signal is received to wake up the portable electronic apparatus. At least one advertisement data is accessed from the memory and displayed on the display device of the portable electronic apparatus.

### CROSS REFERENCE TO RELATED APPLICATION

This application claims the priority benefit of U.S. Patent Provisional Application Ser. No. 61/914,041, filed on Dec. 10, 2013, the full disclosure of which is incorporated herein by reference.

### BACKGROUND

1. Disclosure Technical Field

This disclosure generally relates to an operation method and, more particularly, to an operation method of a portable electronic apparatus.

2. Related Art

In the past, in order to promote new products or improve the visibility of stores and products, manufacturers or store owners set a variety of advertisements on streets for publicity. As technology advances, the electronic advertisements are broadcasted on television to convey the relevant advertisement information to everyone.

Although, the electronic advertisement broadcasted on television may achieve the effect of publicity, the effects may have limitation. However, with the prevalence of portable electronic devices (such as the mobile phones, the tablet computers), people gradually get used to using the portable electronic devices for a long time so as to search data and read the related information. Therefore, provision of the advertisement information needs improvement.

### SUMMARY

The disclosure provides an operation method of a portable electronic apparatus, thereby providing a platform such that the advertiser may provide advertisement information by the platform.

The disclosure provides an operation method of a portable electronic apparatus. The operation method includes the following steps. At least one advertisement data is downloaded into a memory of the portable electronic apparatus according to a predetermined rule. An input signal is received to wake up the portable electronic apparatus. The at least one advertisement data is accessed from the memory and the at least one advertisement data is displayed on a display device of the portable electronic apparatus.

The disclosure further provides an operation method of a portable electronic apparatus. The operation method includes the following steps. The portable electronic apparatus enters an using state. At least one advertisement data is downloaded into a memory of the portable electronic apparatus according to a predetermined rule. The portable electronic apparatus enters a standby state, wherein the standby state includes a locking state or a sleep state. The at least one advertisement data is accessed from the memory after a third predetermined period and the at least one advertisement data is displayed on a display device of the portable electronic apparatus.

According to the operation method of the portable electronic apparatus disclosed in the exemplary embodiments, at least one advertisement data is downloaded into the memory of the portable electronic apparatus according to a predetermined rule, and after the portable electronic apparatus is waked-up, the portable electronic apparatus accesses the advertisement data from the memory and displays the advertisement data on the display device of the portable electronic apparatus. Additionally, after the at least one advertisement is downloaded into the memory of the portable electronic apparatus, the portable electronic apparatus enters a locking state or asleep state, and the portable electronic apparatus accesses the at least one advertisement data from the memory after the predetermined period and displays the at least one advertisement data on the display device of the portable electronic apparatus. Therefore, a platform is provided for the advertisers to provide the advertisement information through this platform so as to increase the effect of publicity and revenues from the advertisement on this platform.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 shows a flowchart of the operation method of the portable electronic apparatus according to a first exemplary embodiment of the disclosure;

FIG. 2 shows a flowchart of the operation method of the portable electronic apparatus according to a second exemplary embodiment of the disclosure;

FIG. 3 shows a flowchart of the operation method of the portable electronic apparatus according to a third exemplary embodiment of the disclosure;

FIG. 4 shows a flowchart of the operation method of the portable electronic apparatus according to a fourth exemplary embodiment of the disclosure;

FIG. 5 shows a exemplary embodiment of a selection design corresponding to the operation command according to an exemplary embodiment of the disclosure;

FIG. 6 shows another exemplary embodiment of a selection design corresponding to the operation command according to an exemplary embodiment of the disclosure;

FIG. 7 shows a flowchart for the operation between the step S412 and the step S416 in the exemplary embodiment of FIG. 4 of the operation method of the portable electronic apparatus;

FIG. 8 shows a flowchart of the operation method of the portable electronic apparatus according to a fifth exemplary embodiment of the disclosure; and

FIG. 9 shows a flowchart of the operation method of the portable electronic apparatus according to a sixth exemplary embodiment of the disclosure.

### DETAILED DESCRIPTION OF THE EMBODIMENTS

Referring to the drawings Exemplary, embodiments of the present disclosure are described in more detail. The detailed description below is intended as a description of various configurations of the subject technology and is not intended to represent the only configuration in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substaintial/substaintially” means, within an acceptable error range, the person skilled in the art may solve the technical problem in a certain error range to achieve the basic technical effect. Additionally the term “couple” or “connect” covers any direct or indirect electrically coupling means. Therefore when one device is electrically connected to another device in the context, that connection may be through a direct electrical connection, or through an indirect electrical connection via other devices and connections. The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

### First Embodiment

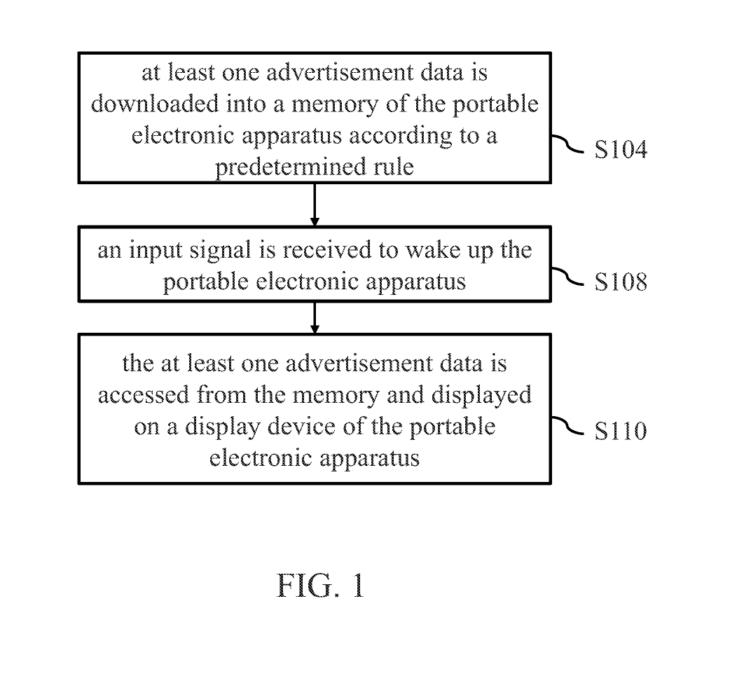

FIG. 1 shows a flowchart of the operation method of the portable electronic apparatus according to a first exemplary embodiment of the disclosure. In the embodiment, the portable electronic apparatus preferably refers to an electronic apparatus with a touch screen, such as a mobile phone, a tablet computer or a personal digital assistant (PDA).

In the step S104, at least one advertisement data is downloaded into a memory of the portable electronic apparatus according to a predetermined rule. That is, the user may operate the portable electronic apparatus and download an application program into the portable electronic apparatus for installation through by Internet such that the portable electronic apparatus may perform the application program. Then, the portable electronic apparatus downloads the advertisement data through the application program according the predetermined rule and stores the advertisement data into the memory of the portable electronic apparatus.

In the embodiment, for example, the at least one advertisement data downloaded into the memory of the portable electronic apparatus may be exemplarily carried out by Internet. Additionally, for example, the at least one advertisement data is downloaded from a database or a server, either of which is provided by the advertiser. That is, when the portable electronic apparatus is connected to Internet and executes the application program, the portable electronic apparatus may connect to the database of the server provided by the advertiser through Internet to obtain the advertisement data stored in the database or the server. Then, the portable electronic apparatus downloads the file of the advertisement data or the set of the predetermined advertisement link and stores them in the memory.

Moreover, the at least one advertisement data includes at least one of a picture, an audio, a URL(Uniform Resource Locator) address, a hyperlink, a video and an animated film. The quantity of the advertisement data is one or more than one, i.e. the portable electronic apparatus may download only one advertisement data into the memory or may download a plurality of advertisement data into the memory at the same time.

Furthermore, the predetermined rule includes, for example, a user-customized rule, most popular advertisement rule, newest advertisement rule or a random rule. For example, if the predetermined rule is the user-customized rule, it means that the user-customized rule may set a classification in advance by the user, such as vehicle, baseball, or health. The portable electronic apparatus downloads the corresponding advertisement data from the database or the server into the memory according the above-mentioned classification.

If the predetermined rule is the most popular advertisement rule, the most popular advertisement data in the database or the server is calculated and sorted by the advertiser. The most popular advertisement data may, for example, be sorted according the browser usage number. The portable electronic apparatus downloads the hottest advertisement data (the maximum advertisement information browsed by the user) from the database or the server into the memory according to the above-mentioned classification.

If the predetermined rule is the newest advertisement rule, for example the newest advertisement data added into the database or the server recently, the portable electronic apparatus downloads the newest advertisement data from the database of the server into the memory according the above-mentioned rule.

If the predetermined rule is the random rule, the portable electronic apparatus randomly downloads the at least one advertisement data from the database of the server into the memory according the above-mentioned rule.

In the step S108, an input signal is received to wake up the portable electronic apparatus. For example, the user may push a power button of the portable electronic apparatus to generate the input signal, such that the portable electronic apparatus performs the wake-up operation after receiving the input signal.

In the step S110, the at least one advertisement data is accessed from the memory and displayed on a display device of the portable electronic apparatus.

In one embodiment, for example, when the quantity of the at least one advertisement data is one, the portable electronic apparatus may access this advertisement data from the memory and display this advertisement data on the display device of the portable electronic apparatus, such that the user may read this advertisement information.

In one embodiment, when the quantity of the at least one advertisement data is more than one, the portable electronic apparatus may download a plurality of advertisement data. The portable electronic apparatus may access these advertisement data from memory and display these advertisement data in sequence every a first predetermined period.

For example, in the condition that the memory stores three advertisement data, such as the advertisement data A, B, C, and the first predetermined period is 5 seconds. Firstly, the portable electronic apparatus displays the advertisement data A; after 5 seconds, the portable electronic apparatus displays the advertisement data B; and then after 5 seconds, the portable electronic apparatus displays the advertisement data C. Further, the portable electronic apparatus may display the advertisement data A, B, C on the display device using a sequential cycle manner, such as A, B, C, A, B, C, . . . . Therefore, the embodiment of the disclosure may provide a platform, and the advertiser provides the advertisement information by the platform so as to increase the effect and income of the advertisement publicity.

### Second Embodiment

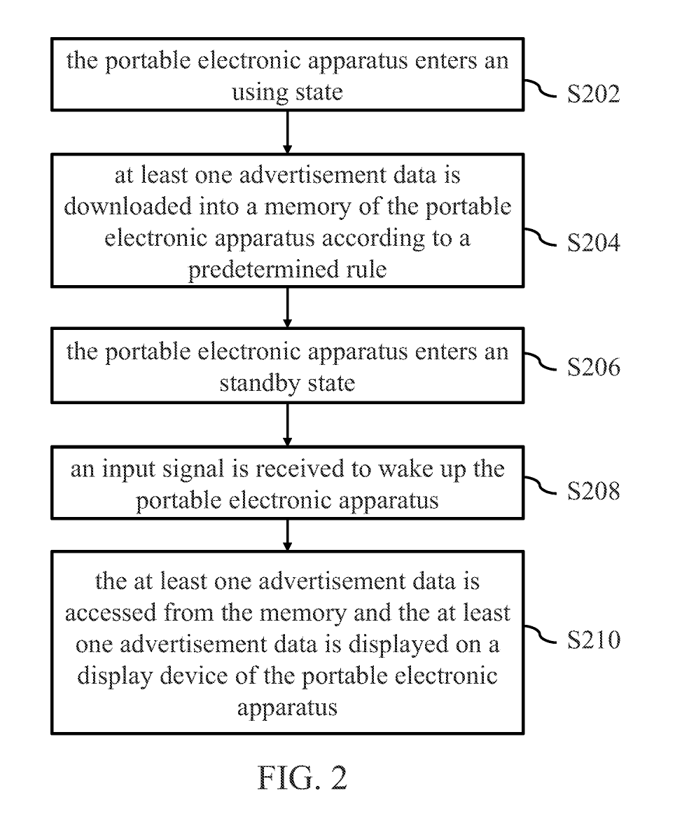

FIG. 2 shows a flowchart of the operation method of the portable electronic apparatus according to a second embodiment of the disclosure. In the step S202, the portable electronic apparatus enters an using state. In the step S204, at least one advertisement data is downloaded into a memory of the portable electronic apparatus according to a predetermined rule.

In the step S206, the portable electronic apparatus enters an standby state. The standby state includes, for example, a locking state or a sleep state. In the step S208, an input signal is received to wake up the portable electronic apparatus. In the step S210, the at least one advertisement data is accessed from the memory and the at least one advertisement data is displayed on a display device of the portable electronic apparatus.

The embodiment in FIG. 2 and the embodiment in FIG. 1 are different. In the embodiment of FIG. 2, the portable electronic apparatus enters the using state firstly, i.e. the state that the user may operate the apparatus normally Then, the portable electronic apparatus downloads the advertisement data into the memory in the using state. After the advertisement data is downloaded completely, the portable electronic apparatus may enters the standby state, i.e. the state that the user may nor operate the apparatus normally. The relative operations of the steps S208 and S210 may refer to the description of the steps S108 and S110 in FIG. 1, and thus the description is omitted. The embodiment in FIG. 2 may have the same effects or similar effects with the embodiment in FIG. 1.

### Third Embodiment

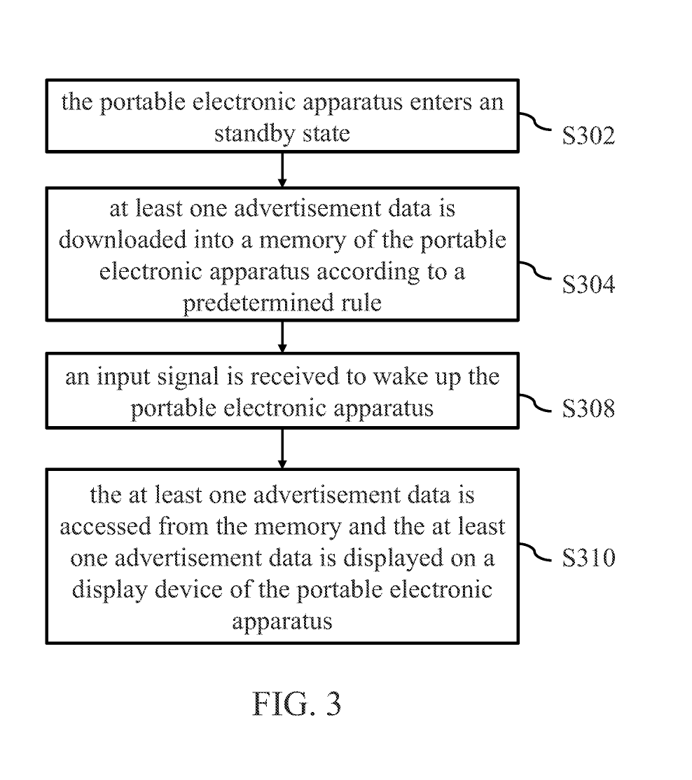

FIG. 3 shows a flowchart of the operation method of the portable electronic apparatus according to a third embodiment of the disclosure.

In the step S302, the portable electronic apparatus enters an standby state. The standby state includes, for example, a locking state or a sleep state. In the step S304, at least one advertisement data is downloaded into a memory of the portable electronic apparatus according to a predetermined rule.

In the step S308, an input signal is received to wake up the portable electronic apparatus. In the step S310, the at least one advertisement data is accessed from the memory and the at least one advertisement data is displayed on a display device of the portable electronic apparatus.

The embodiment in FIG. 3 and the embodiment in FIG. 1 are different. In the embodiment of FIG. 3, the portable electronic apparatus enters the standby state firstly, i.e. the state that the user may not operate the apparatus normally. Then, the portable electronic apparatus downloads the advertisement data into the memory in the standby state. The relative operations of the steps S308 and S310 may refer to the description of the steps S108 and S110 in FIG. 1, and thus the description is omitted. The embodiment in FIG. 3 may have the same effects or similar effects with the embodiment in FIG. 1.

### Fourth Embodiment

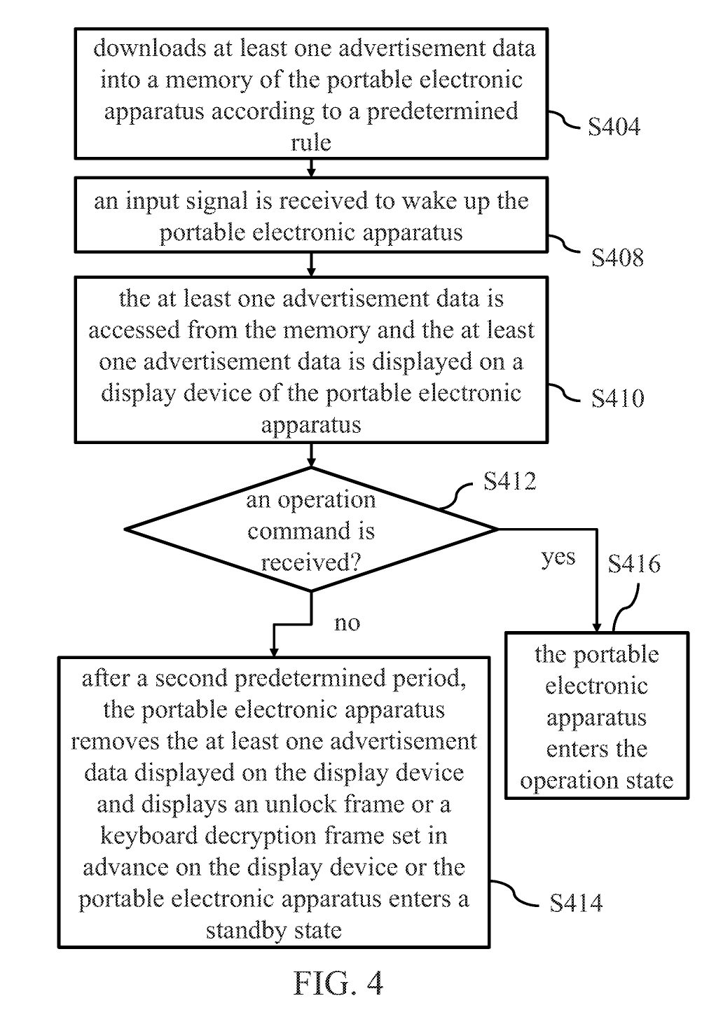

FIG. 4 shows a flowchart of the operation method of the portable electronic apparatus according to a fourth embodiment of the disclosure. In the step S404, the portable electronic apparatus downloads at least one advertisement data into a memory of the portable electronic apparatus according to a predetermined rule (the portable electronic apparatus is in the using state or the standby state). In the step S408, an input signal is received to wake up the portable electronic apparatus. In the step S410, the at least one advertisement data is accessed from the memory and the at least one advertisement data is displayed on a display device of the portable electronic apparatus. In the embodiment, the relatives operations of the steps S404, S408 and S410 may refer to the description of the steps S104, S108 and S110 in FIG. 1, and thus the description is omitted.

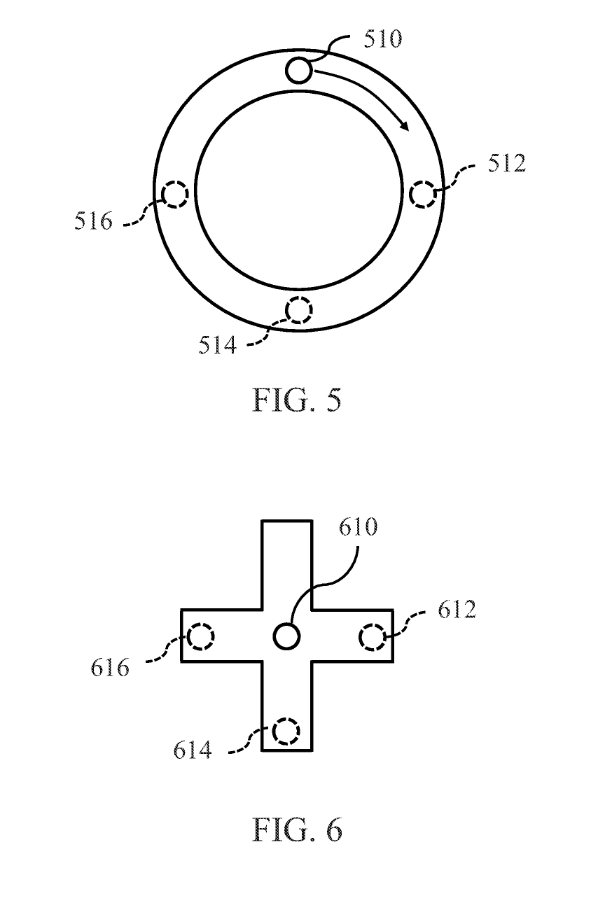

The step S412 determines whether an operation command is received. In the embodiment, the operation command includes, for example, a unlock command, a unlock and reading advertisement command, and a reading advertisement command. After the portable electronic apparatus displays the advertisement data on the display device, the portable electronic apparatus also displays a selection menu showing the unlock command, the unlock and reading advertisement command, and the reading advertisement command The selection menu may be a circle pattern as shown in FIG. 5 or a cross-shaped pattern as shown in FIG. 6.

In FIG. 5, the number 510 refers to, for example, a selected operation button. The operation button is slid by the user clockwise according the arrowhead direction. The number 512 refers to, for example, a corresponding position of the unlock command. That is, the selected operation command is the unlock command when the operation button 510 is slid to the number 512. The number 514 refers to, for example, a corresponding position of the unlock and reading advertisement command. That is, the selected operation command is the unlock and reading advertisement command when the operation button 510 is slid to the number 514. The number 516 refers to, for example, a corresponding position of the reading advertisement command. That is, the selected operation command is the reading advertisement command when the operation button 510 is slid to the number 516.

In FIG. 6, the number 610 refers to, for example, a selected operation button. The operation button is slid by the user towards the left, towards the right or downward. The number 612 refers to, for example, to a corresponding position of the unlock command. That is, the selected operation command is the unlock command when the operation button 610 is slid towards the right to the number 612. The number 614 refers to, for example, a corresponding position of the unlock and reading advertisement command. That is, the selected operation command is the unlock and reading advertisement command when the operation button 610 is slid downward to the number 614. The number 616 refers to, for example, a corresponding position of the reading advertisement command. That is, the selected operation command is the reading advertisement command when the operation button 610 is slid towards the left to the number 616. In above-mentioned embodiment, the selection menu of the operation command used the circle pattern shown in FIG. 5 or the cross-shaped pattern in FIG. 6 is only one of the embodiments in the disclosure, and it is not used to limit the disclosure. The selection menu of the operation command may be adjusted according to the actual requirement.

If the operation command is not received, the process goes to the step S414. After a second predetermined period, the portable electronic apparatus removes the at least one advertisement data displayed on the display device and displays an unlock frame or a keyboard decryption frame set in advance on the display device or the portable electronic apparatus enters a standby state. That is, the user does not operate the selection menu in FIG. 5 or FIG. 6, i.e. the portable electronic apparatus does not receive the operation command, and the portable electronic apparatus still displays the advertisement data on the display device. After a period of time (i.e. the second predetermined period, such as 3 seconds), the portable electronic apparatus removes the advertisement data displayed on the display device and displays a predetermined mode and then the portable electronic apparatus displays the unlock frame or keyboard decryption frame or enters the standby state once again, such that the user may use the following operation.

On the other hand, if the operation command is received, the process goes to the step S416. The portable electronic apparatus enters the operation state. Further, in one embodiment, if the operation command received by the portable electronic apparatus is the unlock command, the portable electronic apparatus performs the unlock operation and enters the using state, such that the user may use the following operation.

In one embodiment, if the operation command received by the portable electronic apparatus is the unlock-and-reading advertisement command, the portable electronic apparatus performs the unlock operation and enters the using state, and the portable electronic apparatus accesses the advertisement data at the same time and displays the advertisement data on the display device, such that the user may use the following operation.

In one embodiment, if the operation command received by the portable electronic apparatus is the reading advertisement command, the portable electronic apparatus dose not perform the unlock operation and is still in the locking state, and the portable electronic apparatus reads the advertisement data at the same time and displays the advertisement data on the display device, such that the user may read this advertisement information.

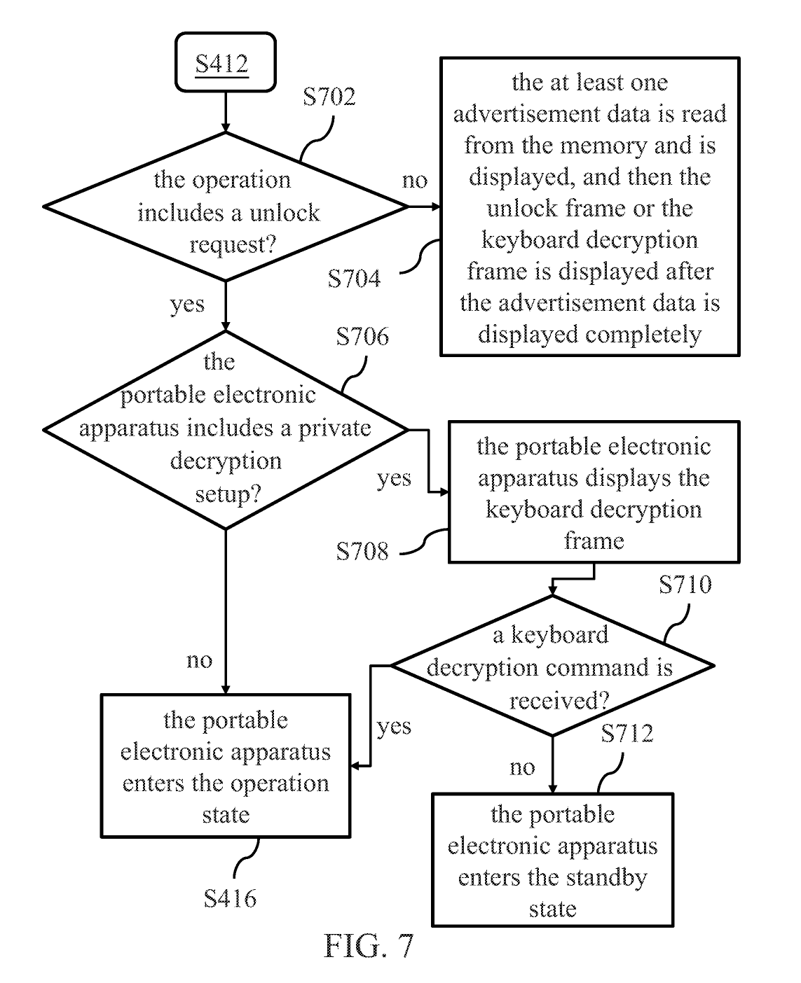

Additionally, there are the steps S702, S704, S706, S708, S710, S712 further introduced between the step S412 and the step S416 in FIG. 4, as shown in FIG. 7.

To continue to the step S412, if the operation command is received, the process goes the step S702, determining the operation command includes a unlock request. That is, it determines whether the operation command inputted by the user includes the command of the unlock request.

If the operation command does not include the unlock request, the process goes the step S704. The at least one advertisement data is read from the memory and is displayed, and then the unlock frame or the keyboard decryption frame is displayed after the advertisement data is displayed completely. That is, the portable electronic apparatus only displays the advertisement data and displays the unlock frame set in advance after the advertisement data is displayed completely, and then the user needs input the unlock command for unlocking the portable electronic apparatus; or the portable electronic apparatus displays the keyboard decryption frame directly after the advertisement data is displayed completely, and then the user needs to input the decryption command for unlocking the portable electronic apparatus.

If the operation command includes the unlock request, the process goes to the step S706, determining whether the portable electronic apparatus includes a private keyboard decryption setup. That is, the user may make the private keyboard decryption setup in the portable electronic apparatus, and the private keyboard decryption setup includes, for example, a password, a pattern, a fingerprint, an iris or a canthus vein, so as to perform the following comparing operation.

If the portable electronic apparatus does not include the private keyboard decryption setup, the process goes the step S416, the portable electronic apparatus enters the operation state, such as the using state, such that the user may use the following operation.

If the portable electronic apparatus includes the private keyboard decryption setup, the process goes to the step S708. The portable electronic apparatus displays the keyboard decryption frame. That is, the keyboard decryption frame displays, for example, buttons of the number “1-9” and a hint for inputting password, and then the user needs to input the corresponding password; or the keyboard decryption frame displays, for example, an input area, and then the user needs to draw the corresponding pattern in the input area; or the keyboard decryption frame still displays, for example, an input area combined with a sensor, and then the user needs to input the corresponding fingerprint, iris or canthus vein by the sensor and the corresponding fingerprint, iris or canthus vein is displayed on the input area.

The step S710 determines whether a keyboard decryption command is received. That is, it determines whether the user pushes the corresponding password, draws the corresponding pattern, or inputs the corresponding fingerprint, iris or canthus vein.

If the keyboard decryption command is not received, the process goes to the step S712. The portable electronic apparatus enters the standby state, i.e. the locking state or the sleep state. If the keyboard decryption command is received, the process goes to the step S416. The portable electronic apparatus enters the operation state, such as the using state, such the user may use the following operation. Therefore, the portable electronic apparatus in the embodiment has a double unlock function to avoid the risk of steal by other people.

Additionally, the above-mentioned double unlock function of the portable electronic apparatus determines whether the unlock request is received (such as the step S702) firstly, and then determines whether the decryption command is received (such as the step S706), but it is not used to limit the disclosure. In another embodiment, the portable electronic apparatus may determines whether the decryption command is received firstly, and then determines whether the unlock request is received, and other steps are adjusted according the corresponding steps in FIG. 7, and the description is omitted.

### Fifth Embodiment

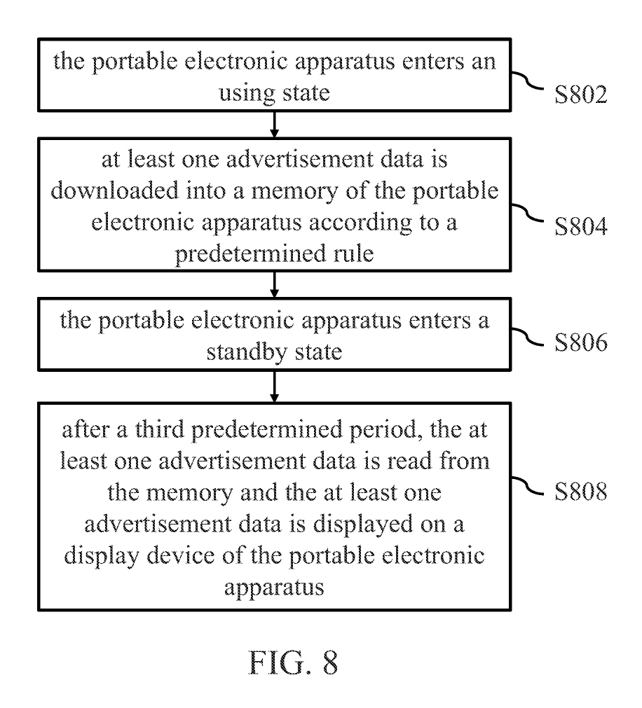

FIG. 8 shows a flowchart of the operation method of the portable electronic apparatus according to a fifth embodiment of the disclosure. In the step S802, the portable electronic apparatus enters an using state. In the step S804, at least one advertisement data is downloaded into a memory of the portable electronic apparatus according to a predetermined rule. In the step S806, the portable electronic apparatus enters a standby state. The standby state includes, for example, a locking state or a sleep state. In the step S808, after a third predetermined period, the at least one advertisement data is read from the memory and the at least one advertisement data is displayed on a display device of the portable electronic apparatus.

In the embodiment, the relative description of the steps S802, S804, S806 may refer to the description of the steps S202, S204, S206 in FIG. 2, the description is omitted. After the portable electronic apparatus enters the standby state, the portable electronic apparatus starts to count. When the counts reaches the third predetermined period, such as 5 seconds, the portable electronic apparatus accesses the at least one advertisement data from the memory and displays the at least one advertisement data on the display device. It may refer to the description of the step S210 in FIG. 2, the description is omitted. The embodiment in FIG. 8 may have the same effect with the embodiment in FIG. 2.

### Sixth Embodiment

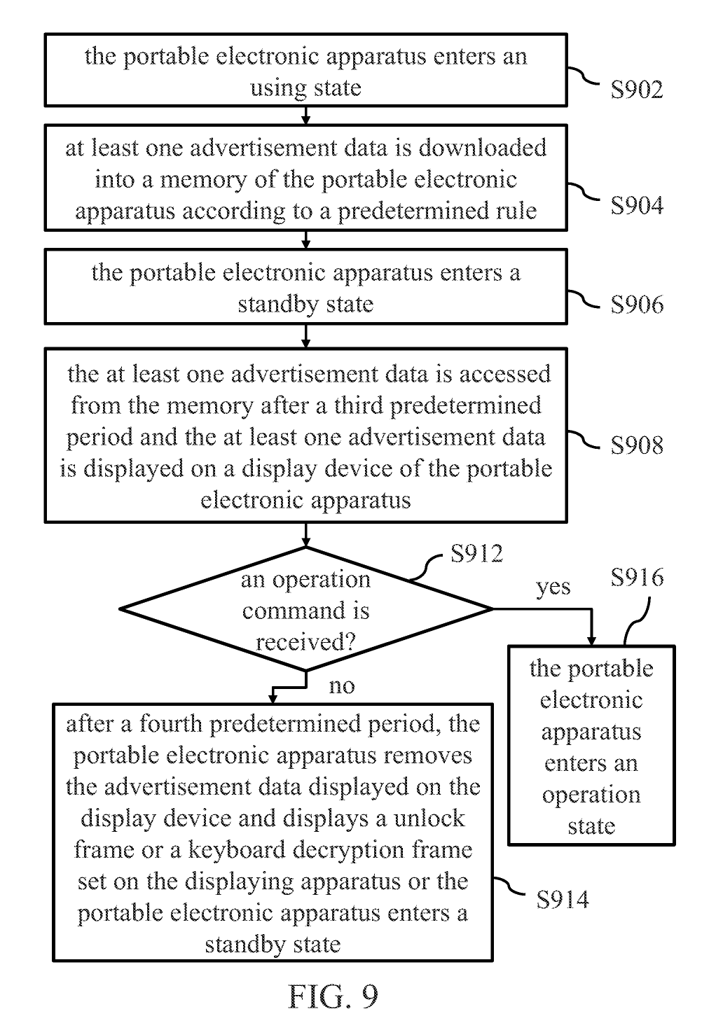

FIG. 9 shows a flowchart of the operation method of the portable electronic apparatus according to a sixth embodiment of the disclosure. In the step S902, the portable electronic apparatus enters an using state. In the step S904, at least one advertisement data is downloaded into a memory of the portable electronic apparatus according to a predetermined rule. In the step S906, the portable electronic apparatus enters a standby state. The standby state includes, for example, a locking state or a sleep state. In the step S908, the at least one advertisement data is accessed from the memory after a third predetermined period and the at least one advertisement data is displayed on a display device of the portable electronic apparatus.

The step 912 determines whether an operation command is received. If the operation command is not received, the process goes to the step S914. After a fourth predetermined period, the portable electronic apparatus removes the advertisement data displayed on the display device and displays a unlock frame or a keyboard decryption frame set on the displaying apparatus or the portable electronic apparatus enters a standby state. If the operation command is received, the step goes to the step S916, in which the portable electronic apparatus enters an operation state.

In the embodiment, the relative description of the steps S902, S904, S906 may refer to the description of the steps S802, S804, S806 in FIG. 8, and thus the description is omitted. The third predetermined period and the fourth predetermined period may, for example, be set to be the same or different. Additionally, the related description of the steps S912, S914, S916 may refer to the description of the steps S412, S414, S416, and thus the description is omitted. Moreover, the steps S702, S704, S706, S708, S710, S712 as shown in FIG. 7 further introduced between the steps S912 and S914 in FIG. 9, and their related description may refer to the description in FIG. 7, and thus the description is omitted. The embodiment in FIG. 9 may have the same effects or similar effects with the embodiment in FIG. 8.

According to the above-mentioned embodiments, the disclosure mainly adopts the portable electronic apparatus to download at least one advertisement data into the memory of the portable electronic apparatus according to a predetermined rule, and after the portable electronic apparatus is waked-up, the portable electronic apparatus accesses the advertisement data from the memory and displays the advertisement data on the display device of the portable electronic apparatus. Additionally, after the at least one advertisement is downloaded into the memory of the portable electronic apparatus, the portable electronic apparatus enters the locking state or the sleep state, and the portable electronic apparatus accesses the at least one advertisement data from the memory after the predetermined period and displays the at least one advertisement data on the display device of the portable electronic apparatus.

Therefore, the disclosure may provide a platform, and the advertiser provides the advertisement information through the platform so as to increase the effect and income of the advertisement.

Although the disclosure has been explained in relation to its preferred embodiment, it does not intend to limit the disclosure. It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. An operation method of a portable electronic apparatus, comprising:
downloading at least one advertisement data into a memory of the portable electronic apparatus according to a predetermined rule;
receiving an input signal to wake up the portable electronic apparatus; and
accessing the at least one advertisement data from the memory and displaying the at least one advertisement data on a display device of the portable electronic apparatus.

2. The operation method of the portable electronic apparatus as claimed in claim 1, wherein after the step of downloading the at least one advertisement data into the memory of the portable electronic apparatus, the operation method further comprises:
the portable electronic apparatus entering a standby state, wherein the standby state comprises a locking state or a sleep state.

3. The operation method of the portable electronic apparatus as claimed in claim 2, wherein before the step of accessing the at least one advertisement data from the memory, the operation method further comprises:
the portable electronic apparatus entering an using state.

4. The operation method of the portable electronic apparatus as claimed in claim 1, wherein before the step of downloading the at least one advertisement data into the memory of the portable electronic apparatus, the operation method further comprises:
the portable electronic apparatus entering a standby state, wherein the standby state comprises a locking state or a sleep state.

5. The operation method of the portable electronic apparatus as claimed in claim 1, wherein the at least one advertisement data comprises a plurality of advertisement data, and the step of displaying the at least one advertisement data on the display device of the portable electronic apparatus comprises the portable electronic apparatus displaying the advertisement data on the display device in sequence every a first predetermined period.

6. The operation method of the portable electronic apparatus as claimed in claim 1, further comprising:
determining whether an operation command is received;
if the operation command is not received after a second predetermined period, the portable electronic apparatus removing the advertisement data displayed on the display device and displaying an unlock frame or a keyboard decryption frame set in advance on the display device, or the portable electronic apparatus entering a standby state; and
if the operation command is received, the portable electronic apparatus entering an operation state.

7. The operation method of the portable electronic apparatus as claimed in claim 6, wherein before the step of the portable electronic apparatus entering the operation state, the operation method further comprises:
determining whether the operation command comprises an unlock request;
if the operation command does not comprises the unlock request, reading at least one advertisement data from the memory and displaying the at least one advertisement data, and displaying the unlock frame or the keyboard decryption frame after displaying the at least one advertisement data completes;
if the operation command comprises the unlock request, determining whether the portable electronic apparatus comprises a private keyboard decryption setup;
if the portable electronic apparatus does not comprise the private keyboard decryption setup, the portable electronic apparatus entering the operation state;
if the portable electronic apparatus comprises the private keyboard decryption setup, the portable electronic apparatus displaying the keyboard decryption frame;
determining whether a keyboard decryption command is received;
if the keyboard decryption command is received, the portable electronic apparatus entering the operation state; and
if the keyboard decryption command is not received, the portable electronic apparatus entering the standby state.

8. The operation method of the portable electronic apparatus as claimed in claim 7, wherein the private keyboard decryption setup comprises a password, a pattern, a fingerprint, an iris or a canthus vein.

9. The operation method of the portable electronic apparatus as claimed in claim 6, wherein the operation command is an unlock command, and the operation state is an using state.

10. The operation method of the portable electronic apparatus as claimed in claim 6, wherein the operation command is an unlock-and-reading advertisement command, the operation state is an using state, and the display device displays the advertisement data.

11. The operation method of the portable electronic apparatus as claimed in claim 6, wherein the operation command is a reading advertisement command, the operations state is a locking state, and the display device displays the advertisement data.

12. The operation method of the portable electronic apparatus as claimed in claim 1, wherein the portable electronic apparatus further displays the advertisement data in a sequential cycle manner.

13. The operation method of the portable electronic apparatus as claimed in claim 1, wherein the predetermined rule comprises a user-customized rule, a most-popular advertisement rule, a newest advertisement rule or a random rule.

14. The operation method of the portable electronic apparatus as claimed in claim 1, wherein the at least one advertisement data is downloaded form a database or a server, the at least one advertisement data is downloaded into the memory of the portable electronic apparatus by a network, and the at least one advertisement data comprises at least one of a picture, an audio, a URL(Uniform Resource Locator) address, a hyperlink, a video and an animated film.

15. An operation method of a portable electronic apparatus, comprising:
the portable electronic apparatus entering an using state;
downloading at least one advertisement data into a memory of the portable electronic apparatus according to a predetermined rule;
the portable electronic apparatus entering a standby state, wherein the standby state comprises a locking state or a sleep state;
after a third predetermined period, reading the at least one advertisement data from the memory and displaying the at least one advertisement data on a display device of the portable electronic apparatus.

16. The operation method of the portable electronic apparatus as claimed in claim 15, further comprising:
determining whether an operation command is received;
if the operation command is not received after a fourth predetermined period, the portable electronic apparatus removing the advertisement data displayed on the display device and displaying a unlock frame or a keyboard decryption frame set on the display device, or the portable electronic apparatus entering a standby state; and
if the operation command is received, the portable electronic apparatus entering an operation state.

17. The operation method of the portable electronic apparatus as claimed in claim 16, wherein before the step of the portable electronic apparatus entering the operation state, the operation method further comprises:
determining whether the operation command comprises an unlock request;
if the operation command does not comprises the unlock request, reading at least one advertisement data from the memory, displaying the at least one advertisement data, and displaying the unlock frame or the keyboard decryption frame after displaying the at least one advertisement data completes;
if the operation command comprises the unlock request, determining whether the portable electronic apparatus comprises a private keyboard decryption setup;
if the portable electronic apparatus does not comprise the private keyboard decryption setup, the portable electronic apparatus entering the operation state;
if the portable electronic apparatus comprises the private keyboard decryption setup, the portable electronic apparatus displaying the keyboard decryption frame;
determining whether a keyboard decryption command is received;
if the keyboard decryption command is received, the portable electronic apparatus entering the operation state; and
if the keyboard decryption command is not received, the portable electronic apparatus entering the standby state.

18. The operation method of the portable electronic apparatus as claimed in claim 15, wherein the operation command is an unlock command, and the operation state is a using state.

19. The operation method of the portable electronic apparatus as claimed in claim 15, wherein the operation command is an unlock-and-reading advertisement command, the operation state is a using state, and the display device displays the advertisement data.

20. The operation method of the portable electronic apparatus as claimed in claim 15, wherein the operation command is a reading advertisement command, the operations state is a locking state, and the display device displays the advertisement data.
